(19) United States
(12) Patent Application Publication
(10) Pub. No.: US 2023/0099840 A1
(43) Pub. Date: Mar. 30, 2023

(54) IN-SITU POLYMERIZED HYBRID POLYMER ELECTROLYTE FOR HIGH VOLTAGE LITHIUM BATTERIES

(71) Applicant: Evonik Operations GmbH, Essen (DE)

(72) Inventors: Shasha Su, Shanghai (CN); Jinhua Jiang, Shanghai (CN); Jing Feng, Shanghai (CN); Jun Yang, Shanghai (CN); Huichao Lu, Shanghai (CN); Zhixin Xu, Shanghai (CN); Hongping Li, Shanghai (CN)

(21) Appl. No.: 17/800,369

(22) PCT Filed: Feb. 18, 2020
(86) PCT No.: PCT/CN2020/075672

§ 371 Date: Aug. 17, 2022

(51) Int. Cl. H01M 10/0562; C08F 224/00; C08K 5/42

(52) U.S. Cl. CPC H01M 10/0562; C08F 224/00; C08K 5/42; H01M 10/0525

(57) ABSTRACT

A monomer material for preparing a polymer electrolyte precursor composition capable to form an in-situ polymerized polymer electrolyte, which comprises, consists essentially of, or consists of A1) a first monomer and optionally A2) a second monomer. A polymer electrolyte precursor raw material composition, a polymer electrolyte precursor composition capable to form a polymer electrolyte comprising the monomer material, a polymer electrolyte and an electrochemical device are also provided.

### TECHNICAL FIELD

The present invention relates to the preparation and development of an in-situ polymerized hybrid polymer electrolytes for high voltage lithium metal batteries.

### BACKGROUND ART

With the development and requirement of various energy storage devices and system especially for electric vehicles, traditional Li-ion batteries can no longer meet market's needs and there is in urgent need of high-energy/power-density lithium batteries. Lithium batteries employing Li metal (−3.04V vs. standard hydrogen electrode, 3860 mAh g⁻¹) as anode and high voltage LiNiₓCo_{y}Mn_{1-x-y}(≥4.3V vs. Li⁺/Li, ≥150 mAh g⁻¹) as cathode are commonly recognized as the next generation of lithium batteries. Except for electrodes, as one of the most important part of the Lithium batteries, electrolytes also play a very important role in the state-of-the-art Li-based batteries. Unfortunately, conventional organic liquid electrolytes employing carbonate or ether-based solvents exhibit poor anodic stability less than 4.3V vs. Li/Li⁺, which makes them highly unstable against novel high-voltage cathodes. Besides, commercial electrolytes contain large amount of organic component which are volatile and flammable. Therefore, polymer electrolytes, especially solid polymer electrolytes (SPEs) are attracting more attentions for its lowered safety risks, high anodic stability and the ability to suppress lithium dendrites.

PEO-based electrolyte is the most commonly investigated among the various known polymers and the structure of which with an oligoether (—CH2-CH2-O—)ₙ can effectively dissolve Li salts. The transport motivation of the Li⁺ in PEO attributes to the flexible ethylene oxide segments and ether oxygen atoms. In most cases, PEO-based electrolytes possess low ionic conductivity due to their high crystallinity and exist ion aggregation phenomenon. Another problem of PEO based electrolytes is the insufficient anti-oxidation capability (mostly <4.2 V vs. Li/Li⁺) which means it is almost impossible for them to match with high voltage cathodes. What's more, ex-situ PEO-based polymer electrolytes have poor wettability with cathodes which can seriously impacts its cycle performance.

Different from traditional ex-situ PEO-based SPEs, in-situ polymerized SPEs is thermally prepared by precursor solution which consists of lithium salt, polymerizable monomer and thermal initiator. And in-situ polymerized SPEs have good wettability with cathode which enable better cycle performance. J. Chai et al. (J. Chai et al. Advance Science, Vol. 4(2016), pp. 1600377) manifested that in-situ polymerized poly (vinylene carbonate) (PVCA) based solid polymer electrolyte possess electrochemical stability window up to 4.5 V versus Li/Li⁺ and ionic conductivity of 9.82×10⁻⁵ S cm⁻¹ at 50° C. for LiCoO₂/Li batteries. The LiCoO₂/Li battery only delivered reversible capacity of about 97 mAh g⁻¹ at a current density of 0.1 C, which was due to the low ionic conductivity of PVCA-SPE and large polarization at 25° C.

### SUMMARY OF THE INVENTION

It is therefore an object of the present invention to develop a novel hybrid solid/gel polymer electrolyte by in-situ polymerization.

The inventors surprisingly found that a monomer material, e.g. unsaturated cyclic carbonated ester monomer with carbon-carbon double bond in side chains and optionally a polyfunctional ester-based crosslinker such as ETPTA may form an excellent polymer skeleton for solid or gel polymer electrolyte after in-situ polymerization. Such polymer electrolyte shows excellent performance such as cycle performance and electrochemical stability window as compared with that of commercial liquid electrolyte. The obtained polymer electrolyte also presents higher ionic conductivity under room temperature compared with traditional PEO-based electrolyte and compact PVCA-based electrolyte. The obtained polymer electrolyte further presents better flexibility than PVCA solid polymer electrolyte thus lithium ion batteries may be made with better flexibility.

### BRIEF DESCRIPTION OF DRAWINGS

FIG. 1 shows the ionic conductivity of the polymer electrolyte prepared in Example 1a.

FIG. 2 shows the electrochemical stability window test result of the polymer electrolyte prepared in Example 1a.

FIG. 3 shows the cycle performance of the electrolytes prepared in Example 1a with Li—NCM523(FIG. 3a) as cathode and in Example 1b with Li—LiFPO₄ (FIG. 3b) as cathode at 0.2 C rate.

FIG. 4 shows the infrared test results proving that VEC and ETPTA had reacted completely according to Example 2-1a.

FIG. 5 shows the ionic conductivity of the polymer electrolytes prepared in Example 2-1a, Example 2-2 and Example 2-3.

FIG. 6 shows the electrochemical stability window test result of the polymer electrolytes prepared in Example 2-1a(FIG. 6a), Example 2-2(FIG. 6b) and Example 2-3(FIG. 6c).

FIG. 7 shows the cycle performance of the polymer electrolytes prepared in Example 2-1a(FIG. 7a), Example 2-2(FIG. 7b) and Example 2-3(FIG. 7c) with NCM523 as cathode and Example 2-1b(FIG. 7d) with LiFePO₄ as cathode at 0.2 C rate.

FIG. 8 shows the ionic conductivity of the polymer electrolytes prepared in Example 3-1, Example 3-2, Example 3-3a and Example 3-4.

FIG. 9 shows the electrochemical stability window test result of the polymer electrolytes prepared in Example 3-1(FIG. 9a), Example 3-2(FIG. 9b), Example 3-3a(FIG. 9c) and Example 3-4(FIG. 9d).

FIG. 10 shows the cycle performance of the polymer electrolytes prepared in Example 3-1(FIG. 10a), Example 3-2(FIG. 10b), Example 3-3a(FIG. 10c) and Example 3-4(FIG. 10d) with NCM523 as cathode and Example 3-3b(FIG. 10e) with LiFePO₄ as cathode at 0.5 C rate.

FIG. 11 shows the electrochemical stability window(FIG. 11a) and cycle performance (FIG. 11b) of the Li—NCM523 battery prepared in Comparative Example 1.

### DETAILED DESCRIPTION OF THE INVENTION

The present invention provides a monomer material (i.e. a monomer composition) for preparing a polymer electrolyte precursor composition capable to form an in-situ polymerized polymer electrolyte, which comprises, consists essentially of, or consists of:

A1) a first monomer, represented by formula (I), more preferably vinyl ethylene carbonate (VEC);

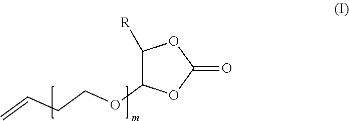

wherein R represents H, F, methyl or ethyl; m represents 0, 1, 2 or 3; and optionally

A2) a second monomer, represented by formula (II), preferably trimethylolpropane ethoxylate triacrylate (ETPTA);

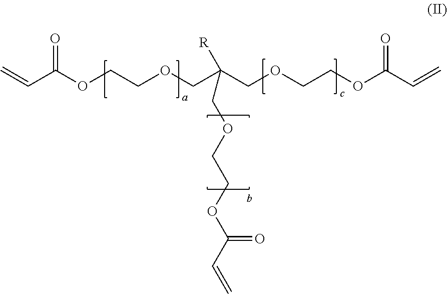

wherein R represents methyl, —CH₂OH, ethyl, or —CH₂CH₂OH, preferably R represents methyl, —CH₂OH or ethyl; a, b and c each independently represents 0, 1, 2 or 3, and a+b+c≥2, preferably a+b+c≥3.

The first monomer, represented by formula (I), is an unsaturated cyclic carbonated ester monomer with a carbon-carbon double bond in a side chain.

Using the monomer material, a polymer electrolyte precursor composition may be prepared, which in turn may be used to form an in-situ polymerized polymer electrolyte.

In some examples, the mass ratio of the first monomer and the second monomer is 9.5:0.5-5:5, for example 9:1-6:4, more preferably 9.5:0.5-8:2, even more preferably 9:1-8:2.

The second monomer may act as a cross-linking agent. Use of the second monomer in the monomer material also helps to obtain a higher electrochemical stability window. However, addition of a cross-linking agent in the monomer material will reduce the ionic conductivity of polymer electrolyte. If the monomer material comprises too much second monomer, the ionic conductivity of the prepared gel-polymer electrolyte will be low.

The present invention further provides a polymer electrolyte precursor raw material composition for preparing a polymer electrolyte precursor composition capable to form an in-situ polymerized polymer electrolyte, which comprises, consists essentially of, or consists of:

A) the monomer material of the present invention; and

B) a free radical initiator for thermal polymerization reaction of the monomer material.

The present invention further provides a polymer electrolyte precursor composition capable to form an in-situ polymerized polymer electrolyte, which comprises, consists essentially of, or consists of:

A) the monomer material of the present invention;

B) a free radical initiator for thermal polymerization reaction of the monomer material; and

C) a lithium salt, preferably lithium bis (fluorosulfonyl) imide; and

D) optionally an organic solvent, preferably a carbonate solvent, more preferably ethylene carbonate/dimethyl carbonate, the weight ratio of the monomer material and the organic solvent is from 1:0 to 1:0.5, preferably 1:0.1-1:0.3, more preferably 1:0.2-1:0.3.

Preferably, the amount of the monomer material is 50-95 wt. %, for example, 60-80 wt. %, 70-80 wt. %, more preferably 75-80 wt. % based on the total weight of the polymer electrolyte precursor composition.

The method for preparing the polymer electrolyte precursor composition capable to form an in-situ polymerized polymer electrolyte of the invention may be conventional, for example a method comprising the step of mixing the components of the polymer electrolyte precursor composition.

The present invention further provides a method to in-situ prepare a polymer electrolyte, comprising the steps as follows,

1) injecting the polymer electrolyte precursor composition of the invention into a battery case, followed by sealing; and

2) polymerizing in-situ the polymer electrolyte precursor composition by heating.

In one example, the polymerization reaction of the first monomer may be schematically shown as follows,

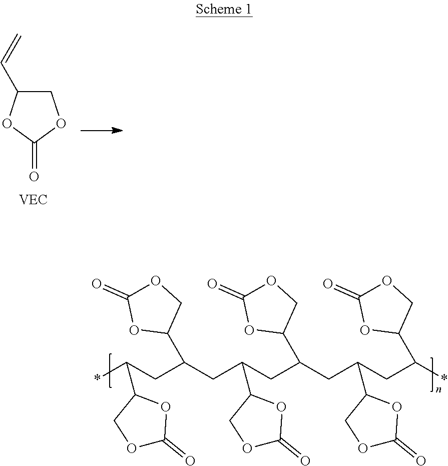

In another example, the reaction of the first monomer and the second monomer may be schematically shown as follows,

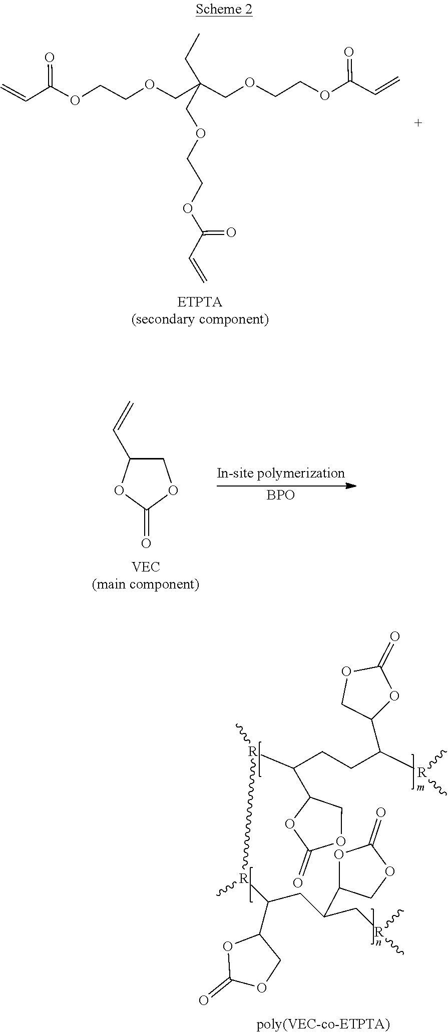

The present invention further provides a polymer electrolyte, particularly a gel or solid polymer electrolyte, wherein the polymer electrolyte is formed by (polymerization of) a polymer electrolyte precursor composition comprising the monomer material of the invention or is prepared according to the method of the invention.

The present invention further provides a polymer electrolyte for rechargeable batteries, comprising a polymer which is the reaction product of the monomer material of the invention with a free radical initiator.

The present invention further provides a polymer electrolyte for rechargeable batteries, comprising:

(i) a polymer which is the reaction product of the monomer material of the invention with a free radical initiator, and

(ii) an organic solvent which contains an amount of an ionic salt effective to achieve an ionic conductivity of about 0.46 mS/cm or less.

In some examples, the ionic salt is a lithium salt.

The present invention further provides a polymer electrolyte prepared in-situ by the polymer electrolyte precursor composition according to the invention. The polymer electrolyte may be prepared according to the conventional methods in the art.

The present invention further provides a rechargeable battery comprising an anode, a cathode, a microporous separator separating said anode and said cathode, and a polymer electrolyte of the present invention.

The present invention further provides a lithium ion battery comprising the polymer electrolyte prepared in-situ by (polymerization of) the polymer electrolyte precursor composition according to the invention.

The present invention further provides an electrochemical device comprising the polymer electrolyte according to the present invention.

In some examples, the electrochemical device is a secondary battery.

The present invention further provides a device fabricated by a process comprising: preparing an installed battery case with an electrode assembly; injecting the polymer electrolyte precursor composition of the invention into the battery case, followed by sealing; and polymerizing the polymer electrolyte precursor composition.

The polymerizing may be performed by heating.

The polymer electrolyte of the invention may be either in gel state (i.e., gel polymer electrolyte) or solid state (i.e., solid polymer electrolyte), preferably, the polymer electrolyte is in gel state. For the polymer electrolyte precursor composition of the invention, the gel or solid state of the polymer electrolyte may be adjusted by the amount of organic solvent in the polymer electrolyte precursor composition. For example, as shown in the Examples 1 and Example 2, when the polymer electrolyte precursor composition comprises no organic solvent, the obtained polymer electrolyte is in solid state; when the polymer electrolyte precursor composition comprises organic solvent as shown in Example 3, the obtained polymer electrolyte is in gel state.

There is no special limitation to the types of lithium ion batteries that may use the electrolyte of the present invention. In some examples, the lithium ion batteries are LMBs.

In some examples, the invention provides a polymer electrolyte precursor composition capable to form a polymer electrolyte, the precursor composition comprising, consisting essentially of, or consisting of:

A) a monomer material consisting of vinyl ethylene carbonate and trimethylolpropane ethoxylate triacrylate;

B) a free radical initiator;

C) a lithium salt, such as lithium bis (fluorosulfonyl) imide; and

D) a organic solvent, preferably a carbonate solvent such as ethylene carbonate/dimethyl carbonate;

wherein the mass ratio of vinyl ethylene carbonate and trimethylolpropane ethoxylate triacrylate is 9.5:0.5-5:5, preferably 9.5:0.5-8:2, more preferably 9:1-8:2; wherein the weight ratio of monomer material and the organic solvent is from 1:0 to 1:0.5, preferably 1:0.1-1:0.3, more preferably 1:0.2-1:0.3; and wherein the amount of the monomer material is 50-95 wt. %, preferably 75-80 wt. % based on the total weight of the polymer electrolyte precursor composition.

The amount of lithium bis (fluorosulfonyl) imide is preferably around 15 wt. % based on the total weight of the polymer electrolyte precursor composition.

The present invention further provides use of the monomer material of the invention, or the polymer electrolyte precursor raw material composition of the invention, or the polymer electrolyte precursor composition of the invention, in preparation of an in-situ polymerized polymer electrolyte or an electrochemical device.

A person skilled in the art can determine suitable separators for the lithium ion batteries with the polymer electrolyte of the invention. For example, the separator may be surface modified or unmodified; the separator may have a thickness of less than 30 μm, even less than 20 μm; the porosity of the separator may be above 70%, even above 80%; the material of the separator may be e.g. cellulose or polytetrafluoroethylene (PTFE).

### First Monomer

In some examples, the carbonated ester monomer is preferably vinyl ethylene carbonate (VEC), with chemical formula: C₅H₆O₃, and CAS login No. 4427-96-7.

### Second Monomer

The second monomer is preferably trimethylolpropane ethoxylate triacrylate (ETPTA), or other monomers with similar molecule structure with ETPTA such as trimethylolpropane triacrylate (TMPTA), pentaerythritol triacrylate (PETA) and so on.

The trimethylolpropane ethoxylate triacrylate (ETPTA) may have an average Mn of around 428 and a CAS login No. 28961-43-5.

### Free Radical Initiator

The free radical initiator of the polymerization reaction of the monomers is for the thermal polymerization reaction of the monomers, and may be those conventional in the art.

Examples of free radical initiator or the polymerization initiator may include azo compounds such as 2,2-azobis(2-cyanobutane), 2,2-azobis(methylbutyronitrile), 2,2′-azoisobutyronitrile (AIBN), azobisdimethyl-valeronitrile (AMVN) and the like, peroxy compounds such as benzoyl peroxide, acetyl peroxide, dilauryl peroxide, di-tert-butyl peroxide, cumyl peroxide, hydrogen peroxide and the like, and hydroperoxides. Preferably, AIBN, 2,2′-azobis(2,4-dimethyl valeronitrile) (V65), Di-(4-tert-butylcyclohexyl)-peroxydicarbonate (DBC), or the like may also be employed.

Preferably the free radical initiator may be selected from azobisisobutyronitrile (AIBN), azobisisoheptanenitrile (ABVN), benzoyl peroxide (BPO), lauroyl peroxide (LPO) and so on. More preferably, the free radical initiator is azobisisobutyronitrile (AIBN).

The amount of the free radical initiator is conventional. Preferably the amount of the free radical initiator is 0.1-3 wt. %, more preferably around 0.5 wt. % based on the total weight of the monomer material.

The polymerization initiator is decomposed at a certain temperature of 40 to 80° C. to form radicals, and may react with monomers via the free radical polymerization to form a gel polymer electrolyte. Generally, the free radical polymerization is carried out by sequential reactions consisting of the initiation involving formation of transient molecules having high reactivity or active sites, the propagation involving re-formation of active sites at the ends of chains by addition of monomers to active chain ends, the chain transfer involving transfer of the active sites to other molecules, and the termination involving destruction of active chain centers.

### Lithium Salt

The lithium salt is a material that is dissolved in the non-aqueous electrolyte to thereby resulting in dissociation of lithium ions.

The lithium salt may be those used conventional in the art but is thermally stable during in-situ polymerization (e.g. at 80° C.), non-limiting examples may be at least one selected from lithium bis (fluorosulfonyl) imide(LiFSI), lithium bis(trifluoromethanesulfonyl)imide (LiTFSI), lithium difluorooxalate borate (LiODFB), LiAsF₆, LiClO₄, LiN(CF₃SO₂)₂, LiBF₄, LiSbF₆, and LiCl, LiBr, Lii, LiB₁₀Cl₁₀, LiCF₃SO₃, LiCF₃CO₂, LiAlCl₄, CH₃SO₃Li, CF₃SO₃Li, (CF₃SO₂)₂NLi, chloroborane lithium, lower aliphatic carboxylic acid lithium, lithium tetraphenyl borate and imide. The lithium salt is preferably selected from LiFSI, LiTFSI and LiODFB. These materials may be used alone or in any combination thereof.

The amount of lithium salt is also conventional, for example 5-40 wt. %, most preferably around 15 wt. % based on the total weight of the polymer electrolyte precursor composition.

### Organic Solvent

The organic solvent may be conventional in the art. For example, the organic solvent may be non-protic organic solvents such as N-methyl-2-pyrollidinone, propylene carbonate (PC), ethylene carbonate (EC), butylene carbonate (BC), dimethyl carbonate (DMC), diethyl carbonate (DEC), ethylmethyl carbonate (EMC), gamma-butyrolactone, dimethylsulfoxide, methyl formate, methyl acetate, phosphoric acid triester, sulfolane, methyl sulfolane, 1,3-dimethyl-2-imidazolidinone, propylene carbonate derivatives, methyl propionate and ethyl propionate. These materials may be used alone or in any combination thereof.

The organic solvent is preferably a carbonate solvent. The carbonate solvent may preferably be selected from the group consisting of ethylene carbonate/dimethyl carbonate (EC/DMC), ethylene carbonate (EC), propylene carbonate (PC), dimethyl carbonate (DMC), ethylmethyl carbonate (EMC), diethyl carbonate (DEC) and gamma-butyrolactone (GBL). In some examples, the organic solvent is preferably ethylene carbonate/dimethyl carbonate (EC/DMC, EC/DMC=50/50 (v/v)).

The amount of the organic solvent is conventional so long as the polymer electrolyte is in gel state. For example, if the amount of organic solvent is exceedingly high and the weight ratio of monomer material and the organic solvent is less than 1:0.5, a good gel state may not be formed.

Additionally, in order to improve charge/discharge characteristics and flame retardancy, for example, pyridine, triethylphosphite, triethanolamine, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the electrolyte. If necessary, in order to impart incombustibility, the electrolyte may further include halogen-containing solvents such as carbon tetrachloride and ethylene trifluoride.

The electrochemical device encompasses all kinds of devices that undergo electrochemical reactions. Examples of the electrochemical device include all kinds of primary batteries, secondary batteries, fuel cells, solar cells, capacitors and the like, preferably secondary batteries.

Generally, the secondary battery is fabricated by inclusion of the electrolyte in an electrode assembly composed of a cathode and an anode, which are faced opposite to each other with a separator therebetween.

The cathode is, for example, fabricated by applying a mixture of a cathode active material, a conductive material and a binder to a cathode current collector, followed by drying and pressing. If necessary, a filler may be further added to the above mixture.

Examples of the cathode active materials that can be used in the present invention may include, but are not limited to, layered compounds such as lithium cobalt oxide (LiCoO₂) and lithium nickel oxide (LiNiO₂), or compounds substituted with one or more transition metals such as LiNiₓCo_{y}Mn_{i-x-y}(NCM); lithium manganese oxides such as compounds of Formula Liᵢ₊ₓMn₂₋ₓO₄ (0≤x≤0.33), LiMnO₃, LiMn₂O₃ and LiMnO₂; lithium copper oxide (Li₂CuO₂); vanadium oxides such as LiV₃O₈, V₂O₅ and Cu₂V₂O₇; Ni-site type lithium nickel oxides of Formula LiNi₁₋ₓMₓO₂ (M=Co, Mn, Al, Cu, Fe, Mg, B or Ga, and 0.01≤×≤0.3); lithium manganese composite oxides of Formula LiMn₂₋ₓMₓO₂ (M=Co, Ni, Fe, Cr, Zn or Ta, and 0.01≤x≤0.1), or Formula Li₂Mn₃MO₈ (M=Fe, Co, Ni, Cu or Zn); LiMn₂O₄ wherein a portion of Li is substituted with alkaline earth metal ions; disulfide compounds; and Fe₂(MoO₄)₃, LiFe₃O₄, etc. In some examples of this invention, LiNi₅Co₂Mn₃ and LiFe₃O₄ are employed as cathodes.

As the polymer electrolytes of the invention show high electrochemical stability windows (>5V), the polymer electrolytes are particularly useful for NCM cathodes.

Examples of the anode active materials utilizable in the present invention include carbon such as non-graphitizing carbon and graphite-based carbon; metal composite oxides such as LiₓFe₂O₃ (0≤x≤1), LiₓWO₂(0≤x≤1) and SnₓMe₁₋ₓMe′_{y}O_{z} (Me: Mn, Fe, Pb or Ge; Me′: Al, B, P, Si, Group I, Group II and Group III elements of the Periodic Table of the Elements, or halogens; 0≤x ≤1; 1≤y≤3; and 1≤z≤8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni based materials. In some examples of this invention, lithium metal is employed as anode.

The secondary battery according to the present invention may be, for example, a lithium metal secondary battery, a lithium-ion secondary battery, a lithium polymer secondary battery, lithium-ion polymer secondary battery or the like. The secondary battery may be fabricated in various forms. For example, the electrode assembly may be constructed in a jelly-roll structure, a stacked structure, a stacked/folded structure or the like. The battery may take a configuration in which the electrode assembly is installed inside a battery case of a cylindrical can, a prismatic can or a laminate sheet including a metal layer and a resin layer. Such a configuration of the battery is widely known in the art.

Therefore, the present invention provides a novel polymer electrolyte by in-situ polymerization of the polymer electrolyte precursor composition of the invention. The polymer electrolyte may be prepared in-situ and the thickness of the electrolyte may be conveniently controlled. Besides, the monomer material, e.g. the first monomer and the second monomer form an excellent polymer skeleton after polymerization, which shows excellent cycle performance and higher electrochemical stability window as compared with that of commercial liquid electrolyte. Furthermore, the polymer electrolyte is less flammable, indicating that it is safer than traditional liquid electrolyte. In addition, when lithium metal is used as anode, lithium dendrite formation can be inhibited owing to the electrolyte's superior mechanical properties. Moreover, the PVEC-based polymer electrolyte basically does not react with lithium foil during the polymerization process compared with PVC. The electrolyte also eliminates the consumption of a large amount of solvents in traditional lithium metal batteries, thus the electrolyte is especially suitable for use in LMBs. Compared with traditional PEO-based polymer electrolyte, the polymer electrolyte of the invention showed superior ionic conductivity, wider electrochemical window and better cycle performance.

Furthermore, the monomer material of the invention is chemically stable, as the first monomer, particularly VEC does not react with Li. This is an important advantage over monomer materials comprising vinylene carbonate (VC), which may adversely react with Li as a side reaction.

Other advantages of the present invention would be apparent for a person skilled in the art upon reading the specification.

### Preparation of a Lithium Metal Battery

The lithium metal batteries were prepared according to the following method:

Step a) preparation of electrolyte precursor composition solution; and

Step b) assembly of a lithium metal battery and in-situ polymerization by heating.

Step a) and b) were performed in a glove box filled with argon gas (H₂O, O₂ ≤0.5 ppm).

To describe the content and effects of the present invention in detail, the present invention will be further described below in combination with the examples and comparative example and with the related drawings.

Unless specified otherwise, all the tests in the examples were performed at room temperature.

### EXAMPLE 1a (Li-NCM523)

1) Preparation of precursor electrolyte solution:

1 g vinyl ethylene carbonate (VEC), 0.157 g lithium bis(fluorosulfonyl)imide (LiFSI) and 3 mg AIBN were mixed and stirred at 25° C. for 0.5 h to obtain a precursor electrolyte solution.

2) Cell assembly and in-situ polymerization by heating:

A LiNi₅Co₂Mn₃(NCM523) cathode was prepared as follows. NCM523, acetylene black, and poly (vinylidene difluoride) in the weight ratio of 80:10:10 were mixed to form a viscous slurry. Then, a flat carbon-coated aluminum foil was coated with the viscous slurry by the doctor blade process. The carbon-coated aluminum foil coated with the viscous slurry was dried at 70° C. for 1 hour in an air-circulating oven and further dried at 100° C. under high vacuum for 12 h to obtain a NCM523 cathode. The mass loading of active material (LiNi₅Co₂Mn₃) was 3-5 mg cm⁻². The precursor electrolyte solution was injected into a 2032 lithium battery with a cellulose separator which separated cathode and anode (Li foil), then the cells were heated at 80° C. for 24 h.

After the heating process, solid polymer electrolyte without flowable liquid phase between the anode and cathode could be obtained. The solid polymer electrolyte could be confirmed as the 2032 battery was disassembled.

### EXAMPLE 1b (Li-LFP)

1) Preparation of precursor electrolyte solution:

1 g vinyl ethylene carbonate (VEC), 0.157 g lithium bis(fluorosulfonyl)imide (LiFSI) and 3 mg AIBN were mixed and stirred at 25° C. for 0.5 h to obtain a precursor electrolyte solution.

2) Cell assembly and in-situ polymerization by heating:

A LiFePO₄ (LFP) cathode was prepared as follows. LFP, acetylene black, and poly (vinylidene difluoride) in the weight ratio of 80:10:10 were mixed to form a viscous slurry. Then, a flat carbon-coated aluminum foil was coated with the viscous slurry by the doctor blade process. The carbon-coated aluminum foil coated with the viscous slurry was dried at 70° C. for 1 hour in an air-circulating oven and further dried at 100° C. under high vacuum for 12 h to obtain a LiFePO₄ cathode. The mass loading of active material (LiFePO₄) was 3-5 mg cm⁻². The precursor electrolyte solution was injected into a 2032 lithium battery with a cellulose separator which separated cathode and anode (Li foil), then the cells were heated at 80° C. for 24 h.

After the heating process, solid polymer electrolyte without flowable liquid phase between the anode and cathode could be obtained. The solid polymer electrolyte could be confirmed as the 2032 battery was disassembled.

### EXAMPLE 2-1a (Li-NCM523)

1) Preparation of precursor electrolyte solution:

0.9 g vinyl ethylene carbonate (VEC), 0.1 g trimethylolpropane ethoxylate triacrylate (ETPTA, average Mn˜428), 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, solid polymer electrolyte without flowable liquid phase between the anode and cathode could be obtained. The solid polymer electrolyte could be confirmed as the 2032 battery was disassembled.

### EXAMPLE 2-1b (Li-LFP)

1) Preparation of precursor electrolyte solution:

0.9 g vinyl ethylene carbonate (VEC), 0.1 g trimethylolpropane ethoxylate triacrylate (ETPTA, average Mn˜428), 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1b.

After the heating process, solid polymer electrolyte without flowable liquid phase between the anode and cathode could be obtained. The solid polymer electrolyte could be confirmed as the 2032 battery was disassembled.

### EXAMPLE 2-2

1) Preparation of precursor electrolyte solution:

0.8 g vinyl ethylene carbonate (VEC), 0.2 g trimethylolpropane ethoxylate triacrylate (ETPTA, average Mn˜428), 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, solid polymer electrolyte without flowable liquid phase between the anode and cathode could be obtained. The solid polymer electrolyte could be confirmed as the 2032 battery was disassembled.

### EXAMPLE 2-3

1) Preparation of precursor electrolyte solution:

0.7 g vinyl ethylene carbonate (VEC), 0.3 g trimethylolpropane ethoxylate triacrylate (ETPTA, average Mn˜428), 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, solid polymer electrolyte without flowable liquid phase between the anode and cathode could be obtained. The solid polymer electrolyte could be confirmed as the 2032 battery was disassembled.

### EXAMPLE 3-1

1) Preparation of precursor electrolyte solution:

0.9 g vinyl ethylene carbonate (VEC), 0.1 g trimethylolpropane ethoxylate triacrylate (ETPTA, average Mn˜428), 0.1 g EC/DMC and 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, gel polymer electrolyte without flowable liquid phase between the anode and cathode could be obtained. The gel polymer electrolyte could be confirmed as the 2032 battery was disassembled.

### EXAMPLE 3-2

1) Preparation of precursor electrolyte solution:

0.9 g vinyl ethylene carbonate (VEC), 0.1 g trimethylolpropane ethoxylate triacrylate (ETPTA, average Mn˜428), 0.2 g EC/DMC and 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, gel polymer electrolyte without flowable liquid phase between the anode and cathode could be obtained. The gel polymer electrolyte could be confirmed as the 2032 battery was disassembled.

### EXAMPLE 3-3a (Li-NCM523)

1) Preparation of precursor electrolyte solution:

0.9 g vinyl ethylene carbonate (VEC), 0.1 g trimethylolpropane ethoxylate triacrylate (ETPTA, average Mn˜428), 0.3 g EC/DMC and 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, gel polymer electrolyte without flowable liquid phase between the anode and cathode could be obtained. The gel polymer electrolyte could be confirmed as the 2032 battery was disassembled.

### EXAMPLE 3-3b (Li-LFP)

1) Preparation of precursor electrolyte solution:

0.9 g vinyl ethylene carbonate (VEC), 0.1 g trimethylolpropane ethoxylate triacrylate (ETPTA, average Mn˜428), 0.3 g EC/DMC and 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1b.

After the heating process, gel polymer electrolyte without flowable liquid phase between the anode and cathode could be obtained. The gel polymer electrolyte could be confirmed as the 2032 battery was disassembled.

### EXAMPLE 3-4

1) Preparation of precursor electrolyte solution:

0.9 g Vinyl ethylene carbonate (VEC), 0.1 g trimethylolpropane ethoxylate triacrylate (ETPTA, average Mn˜428), 0.4 g EC/DMC and 0.157 g LiFSI and 3 mg AIBN were mixed and stirred at 25° C. for 0.5 h to obtain a precursor electrolyte solution.

2) Cell assembly and in-situ polymerization by heating was conducted according to the same method as Example 1a.

After the heating process, gel polymer electrolyte without flowable liquid phase between the anode and cathode could be obtained. The gel polymer electrolyte could be confirmed as the 2032 battery was disassembled.

### COMPARATIVE EXAMPLE 1

### Cell Assembly:

The commercial liquid electrolyte 1M LiPF₆ in EC/DMC (v/v 1/1) was injected into a 2032 lithium battery with polypropylene (PP) separator which separated cathode and anode in which cathode and anode were the same with Example 1a.

### Characterization of the Structure of the Polymer Electrolyte

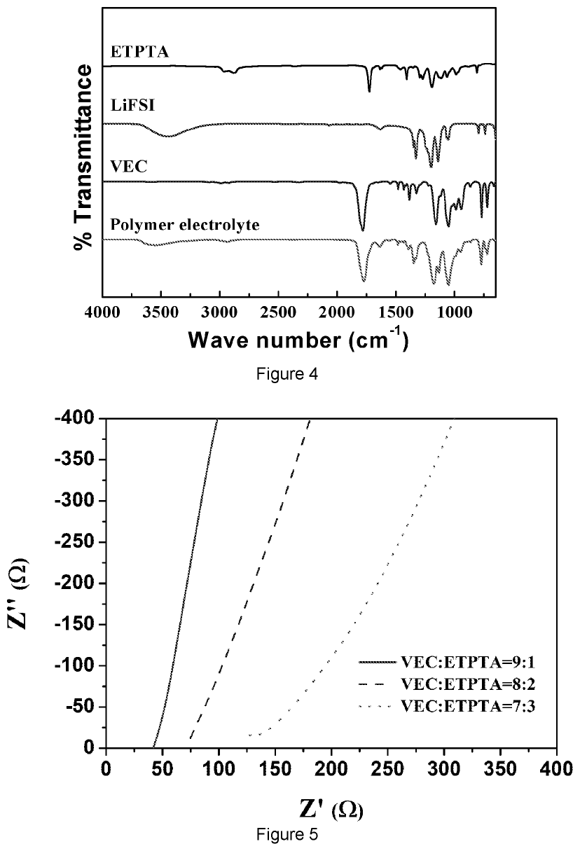

Fourier transform infrared spectroscopy (FTIR) was further conducted to analyze the chemical structure of the solid polymer electrolyte prepared in Example 2-1a. As can be seen from FIG. 4, after polymerization, the absorption peak at 2900 cm⁻¹, 2950 cm^{—1} of terminal double bond hydrogen (—C═CH₂) and 915-905 cm⁻¹, 995-985 cm⁻¹ of —C═C— group disappeared which was well assigned to the chemical structure change of the C═C double bond into C—C single bond.

### Performance Tests

### 1. Cycle Performance of the Electrolyte

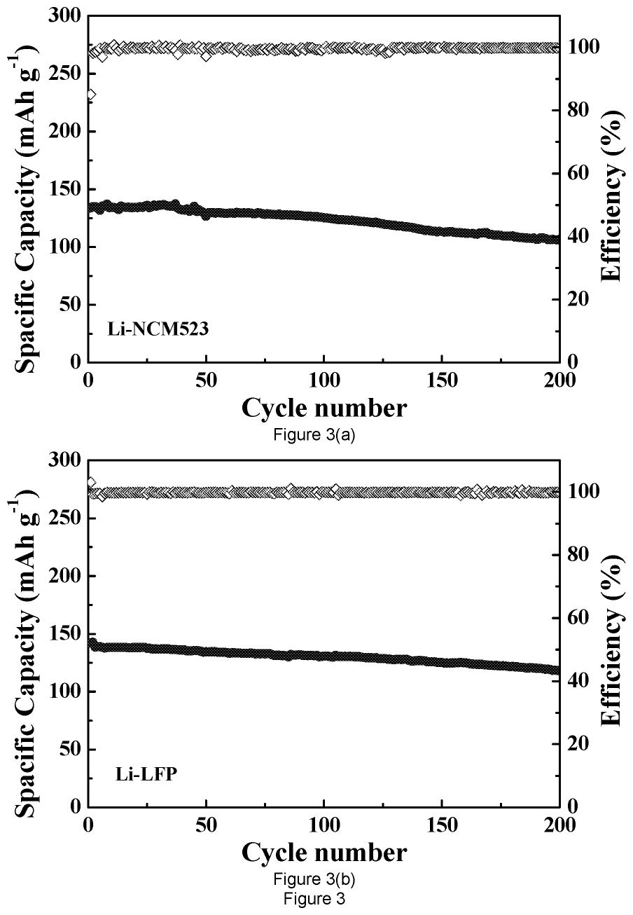

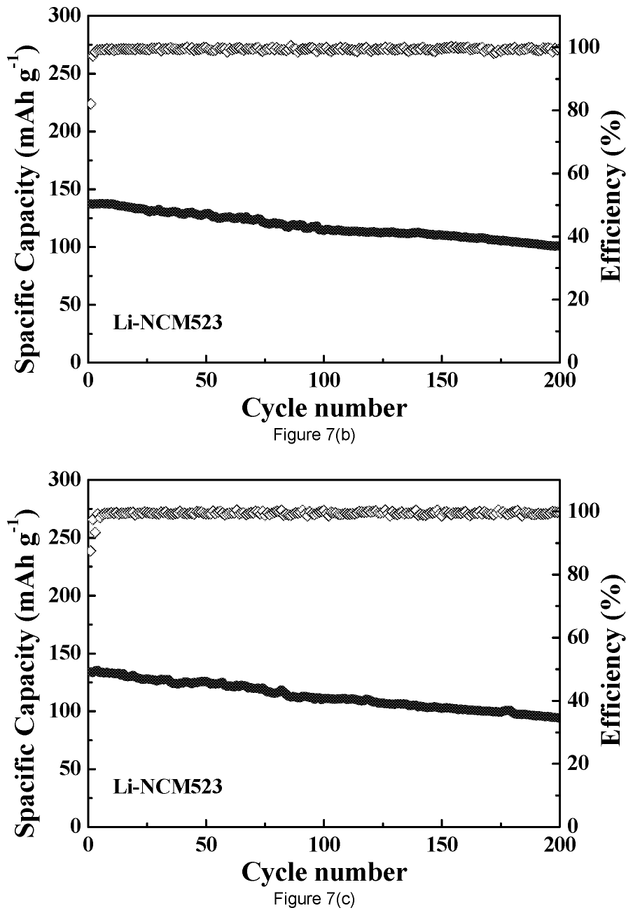

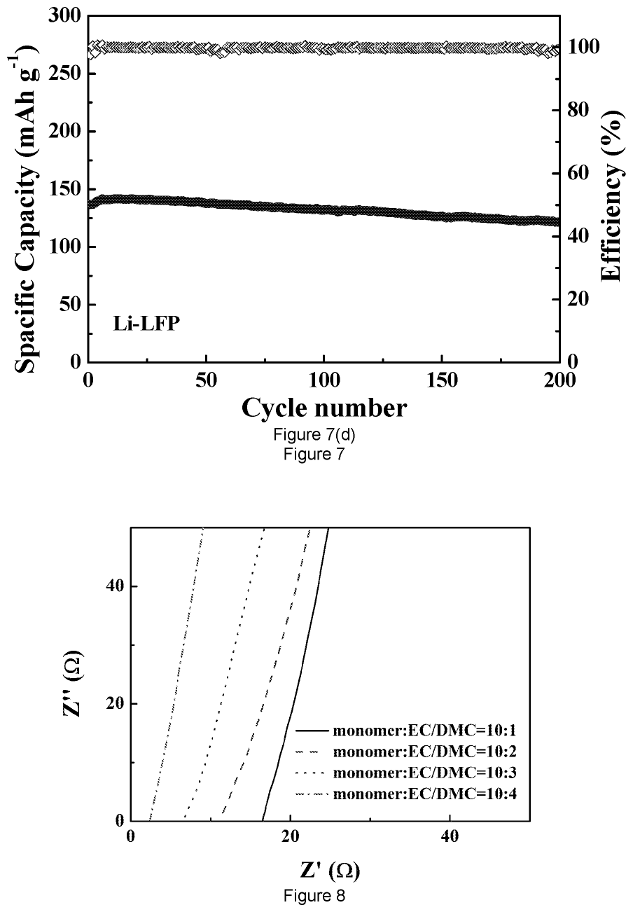

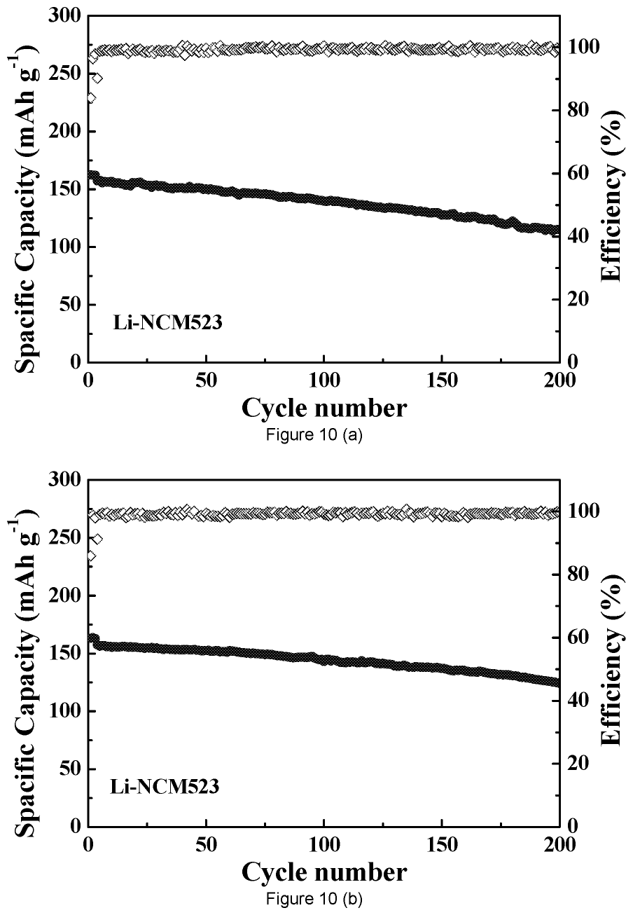

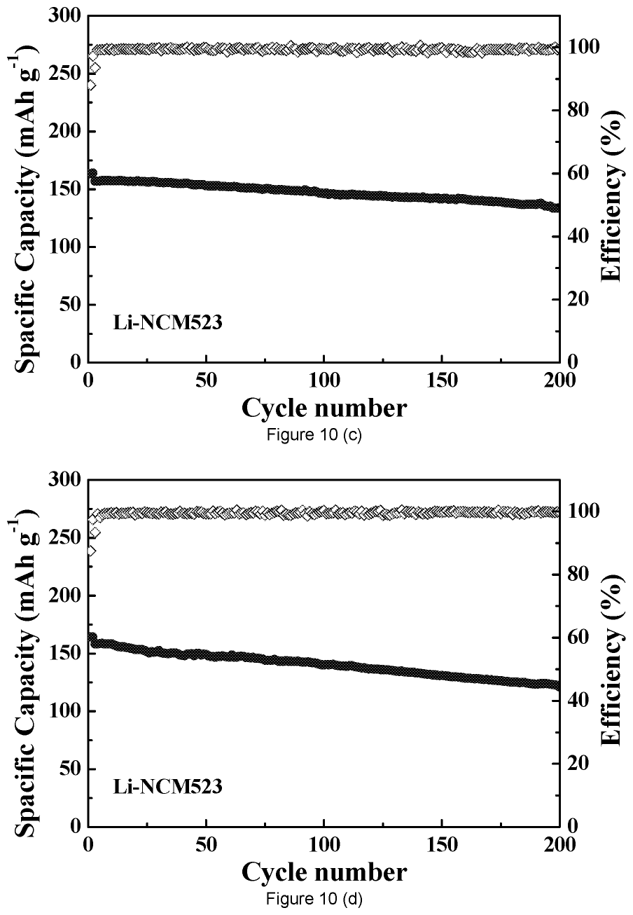

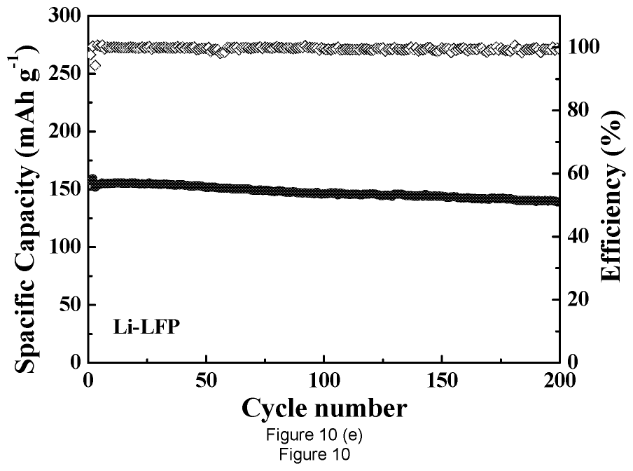

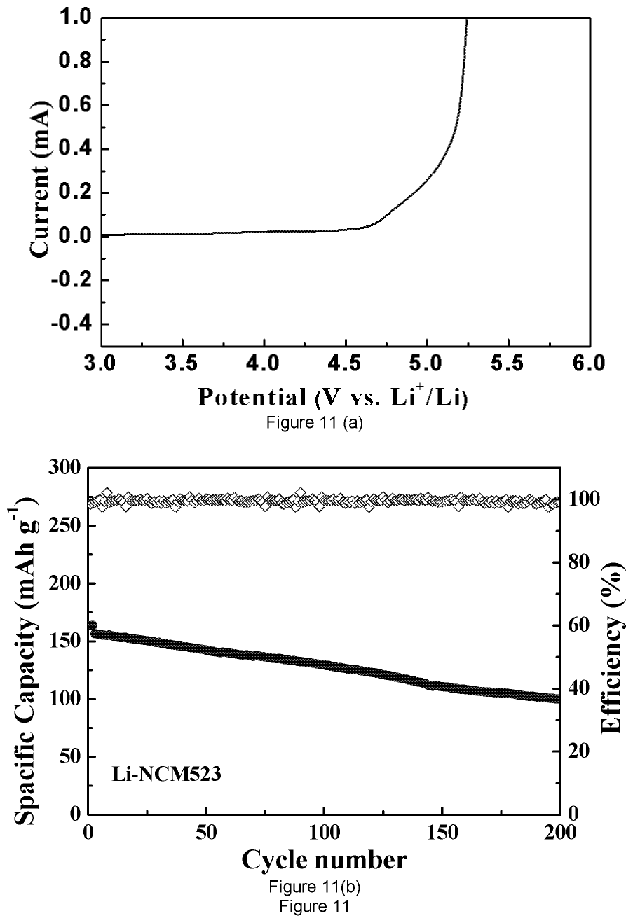

The cycle performance of batteries was evaluated by using LiNi₅Co₂Mn₃ or LiFePO₄ as the cathode and Li metal as the anode at room temperature on a LAND battery testing system (Wuhan Kingnuo Electronics Co., Ltd., China). The cut-off voltage was 4.3V/4.2 V versus Li/Li⁺ for charge (Li extraction) and 2.7V/2.4 V versus Li/Li⁺ for discharge (Li insertion). All the related batteries would be activated by a small current before cycling. The C rates in all the electrochemical measurements were defined based on 1 C=160 mA g ⁻¹. The test results are shown in FIG. 3, FIG. 7, FIG. 10 and FIG. 11. In each figure, the solid points represent discharge capacity and the hollow points represents coulombic efficiency.

For FIG. 11, the batteries were evaluated at 0.2 C rate. Although it delivered higher discharge capacity in the first few cycles of the batteries Comparative Example 1, it decreased rapidly after cycle for 200 times with capacity retention of 64.1%, and coulombic efficiency of the electrolytes of Comparative Example 1 was >99%.

For FIG. 3 and FIG. 7, the batteries were evaluated at 0.2 C rate. The cycling performance with solid polymer electrolyte of Example 1 and Example 2-(1-3) exhibited obviously more outstanding cycle performance as their discharge capacity did not decrease obviously like Comparative Example 1 and the capacity retention after cycled for 200 times of Example 1a and Example 2-(1-3) were 78.9%, 80.5%, 73.5%, 70.2%, respectively with NCM523 as cathode, and the capacity retention in FIG. 3 of Example 1b and FIG. 7 of Example 2-1b with LiFePO₄ as the cathode were 85.5% and 86.8%. Coulombic efficiency of all the batteries as shown in Table 1 were >99%, which meant that the solid polymer electrolyte prepared in Example 1 and Example 2-(1-3) of the invention had a significantly beneficial effect on the cycle performance.

For FIG. 10, the batteries were evaluated at 0.5 C rate. The cycling performance with gel polymer electrolyte of Example 3-(1-4) delivered higher discharge capacity as their ionic conductivity are higher than the solid ones. Capacity retention after cycled for 200 times of Example 3-(1-4) were 73.2%, 79.0%, 85.4%, 77.1%, respectively with NCM523 as cathode, and the capacity retention in FIG. 10 of Example 3-3b with LiFePO₄ as the cathode were 89.7%.

TABLE 1

| | | Capacity retention (%) | |
|---|---|---|---|
| Examples | | Li-LiNi₅Co₂Mn₃ | Li-LiFePO₄ |
| 0.2 C | Example 1 | 78.9 | 85.5 |
| | Example 2-1 | 80.5 | 86.8 |
| | Example 2-2 | 73.5 | — |
| | Example 2-3 | 70.2 | — |
| 0.5 C | Example 3-1 | 73.2 | — |
| | Example 3-2 | 79.0 | — |
| | Example 3-3 | 85.4 | 89.7 |
| | Example 3-4 | 77.1 | — |
| 0.2 C | Comparative Example 1 | 64.1 | — |

However, the cells contained all solid-state polymer electrolytes exhibited lower specific capacity due to their low ionic conductivity than gel polymer and liquid electrolyte.

### 2. Electrochemical Stability Window

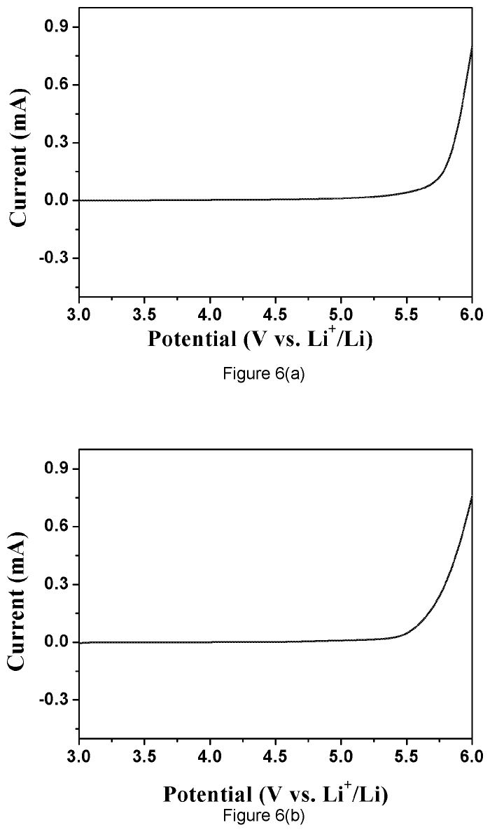

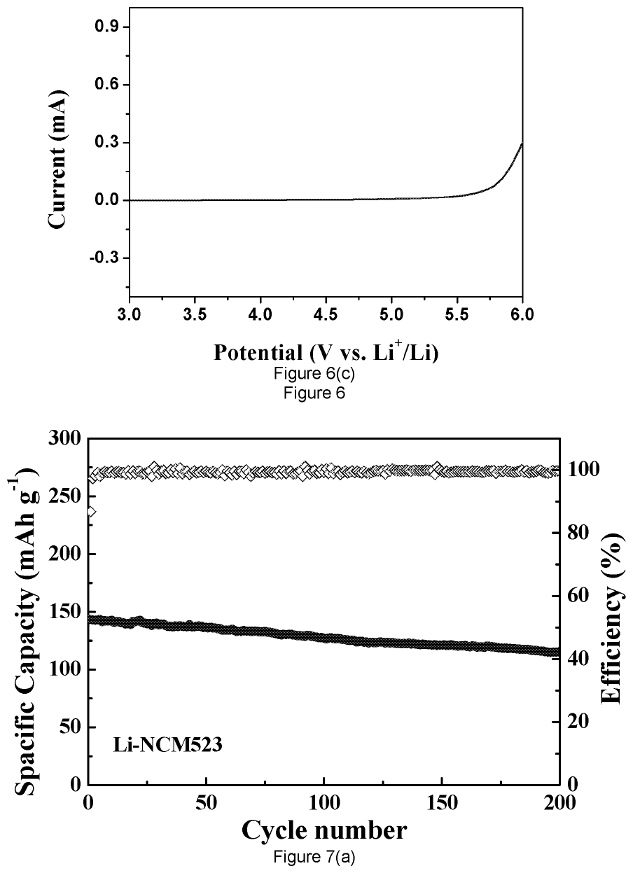

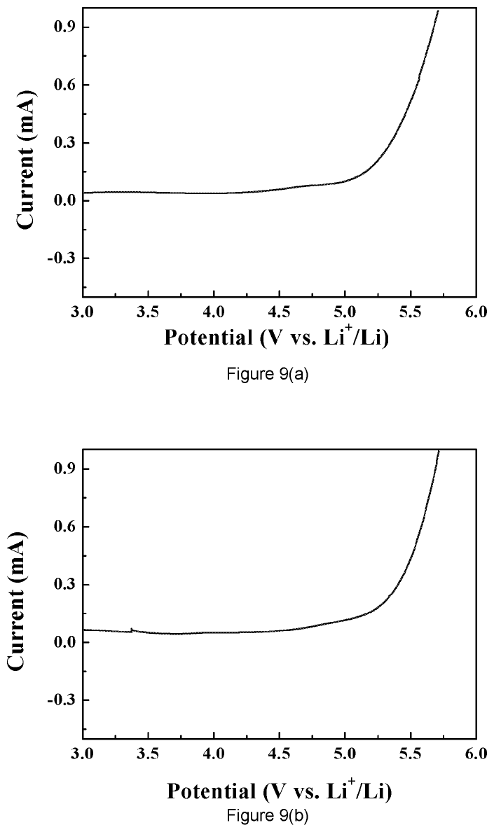

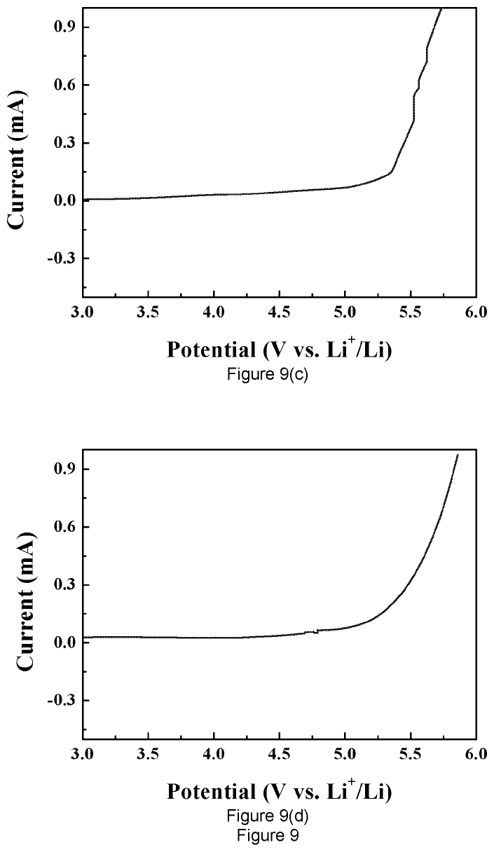

The electrochemical stability of polymer electrolyte of the invention and the liquid electrolyte of Comparative Example 1 was evaluated by linear sweep voltammetry (LSV) performed with SS (stainless steel)/ gel-polymer electrolyte (GPE)/Li coin cell at a scan rate of 10 mV S⁻¹ from open circuit voltage of each cell to 6 V vs. Li⁺/Li at room temperature in a CHI760e electrochemical workstation (Shanghai Chenhua Instruments Co., Ltd.). The results obtained by the test are shown in FIG. 2, FIG. 6, FIG. 9 and FIG. 11.

FIG. 2, FIG. 6 and FIG. 9 show the electrochemical stability window of the polymer electrolytes and FIG. 11 shows the electrochemical stability window of liquid electrolyte. The liquid electrolyte of Comparative Example 1 shows an electrochemical stability window of approximately 4.6 V. Obviously, the polymer electrolytes have higher electrochemical stability windows than that of the liquid electrolyte. The polymer electrolyte according to the present invention showed a more stable electrochemical stability window, e.g., Example 1a(4.8V), Example 2-(1-3) (5.2V) and Example 3-(1-4) (5V), which could contribute to better electrochemical performance. A very stable electrochemical stability window of near or higher than 5V is very important, which makes it possible to use novel high-nickel content cathodes in batteries.

### 3. Ionic Conductivity

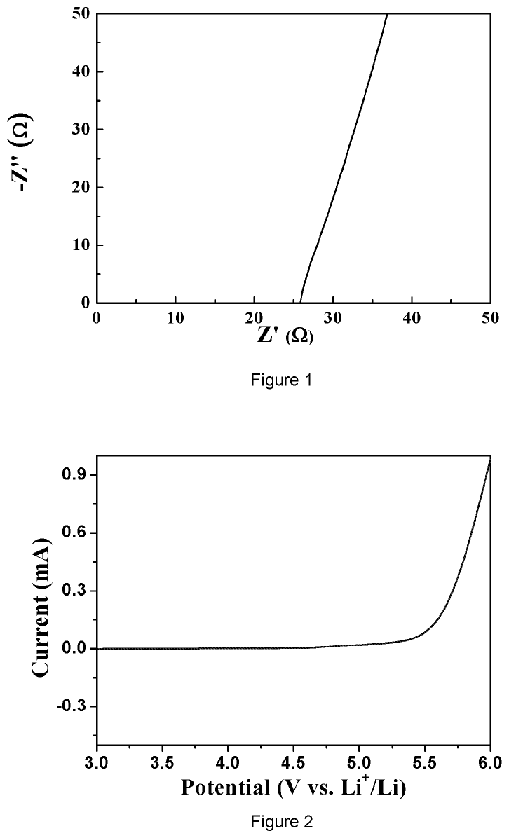

Alternating current (AC) impedance spectroscopy was measured in the CHI760e electrochemical workstation. The ionic conductivity of polymer electrolytes was measured by SS/GPE/SS cell with an applied voltage of 5 mV and the results are shown in FIG. 1, FIG. 5 and FIG. 8 and the ionic conductivity of the electrolytes in different examples were calculated based on FIG. 1, FIG. 5 and FIG. 8 and summarized in Table 2 below.

TABLE 2

| | ionic conductivity |
|---|---|
| | (10⁻⁴S/cm) |
| Example 1a | 0.696 |
| Example 2-1a | 0.434 |
| Example 2-2 | 0.238 |
| Example 2-3 | 0.143 |
| Example 3-1 | 1.101 |
| Example 3-2 | 1.553 |
| Example 3-3a | 2.626 |
| Example 3-4 | 4.567 |
| PVCA-SPE | 0.195 |
| PEO-SPE | 0.021 |

Compared with the PVCA solid polymer electrolyte disclosed in J. Chai et al.(J. Chai et al. Advance Science, Vol. 4(2016), pp. 1600377), which disclosed a PVCA polymer electrolyte with ionic conductivity of 1.95×10⁻⁵ S/cm at room temperature, the ionic conductivity of the solid polymer electrolyte of the invention (6.96×10⁻⁵ S/cm in Example 1a) is higher. Also, the ionic conductivity is much higher than that of traditional PEO-based solid polymer electrolyte which can only offer a very low ionic conductivity of about 2.1×10⁻⁶ S/cm (K. Wen et al. J. Mater. Chem. A, Vol.6 (2018), pp 11631-11663).

As used herein, terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A monomer material for preparing a polymer electrolyte precursor composition capable to form an in-situ polymerized polymer electrolyte, which comprises, consists essentially of, or consists of:
A1) a first monomer, represented by formula (I), more preferably vinyl ethylene carbonate; 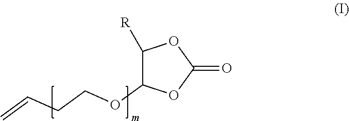
wherein R represents H, F, methyl or ethyl; m represents 0, 1, 2 or 3; and
A2) a second monomer, represented by formula (II), preferably trimethylolpropane ethoxylate triacrylate; 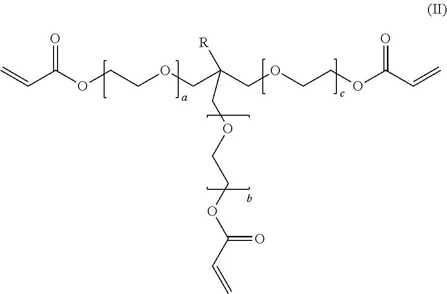
wherein R represents methyl, —CH₂OH, ethyl, or —CH₂CH₂OH, preferably R represents methyl, —CH₂OH or ethyl; a, b and c each independently represents 0, 1, 2 or 3, and a+b+c≥2, preferably a+b+c≥3;
preferably the mass ratio of the first monomer and the second monomer is 9.5:0.5-5:5, more preferably 9.5:0.5-8:2, even more preferably 9:1-8:2.

2. A polymer electrolyte precursor raw material composition for preparing a polymer electrolyte precursor composition capable to form an in-situ polymerized polymer electrolyte, which comprises, consists essentially of, or consists of:
A) the monomer material of claim 1; and
B) a free radical initiator for thermal polymerization reaction of the monomer material.

3. A polymer electrolyte precursor composition capable to form an in-situ polymerized polymer electrolyte, which comprises, consists essentially of, or consists of:
A) the monomer material of claim 1;
B) a free radical initiator for thermal polymerization reaction of the monomer material; and
C) a lithium salt, preferably lithium bis (fluorosulfonyl) imide; and
D) optionally an organic solvent, preferably a carbonate solvent, more preferably ethylene carbonate/dimethyl carbonate, the weight ratio of the monomer material and the organic solvent is from 1:0 to 1:0.5, preferably 1:0.1-1:0.3, more preferably 1:0.2-1:0.3.

4. The polymer electrolyte precursor composition of claim 3, wherein the amount of the monomer material is 50-95 wt. %, preferably 60-80 wt. %, more preferably 75-80 wt. % based on the total weight of the polymer electrolyte precursor composition.

5. A method to in-situ prepare a polymer electrolyte, comprising the steps as follows:
1. injecting the polymer electrolyte precursor composition of claim 3 into a battery case with an electrode assembly, followed by sealing; and
2. polymerizing in-situ the polymer electrolyte precursor composition by heating.

6. A polymer electrolyte, wherein the polymer electrolyte is formed by a polymer electrolyte precursor composition of claim 3 or is prepared according to the method of claim 5.

7. A polymer electrolyte for rechargeable batteries, comprising a polymer which is the reaction product of the monomer material of claim 1 with a free radical initiator.

8. A polymer electrolyte for rechargeable batteries, comprising:
(i) a polymer which is the reaction product of the monomer material of claim 1 with a free radical initiator, and
(ii) an organic solvent which contains an amount of an ionic salt effective to achieve an ionic conductivity of about 0.46 mS/cm or less.

9. A rechargeable battery comprising an anode, a cathode, a microporous separator separating said anode and said cathode, and a polymer electrolyte according to any one of claims 6-8.

10. A lithium ion battery comprising the polymer electrolyte prepared in-situ by the polymer electrolyte precursor composition of claim 3.

11. electrochemical device comprising the polymer electrolyte according to any one of claims 6-8.

12. A device fabricated by a process comprising:
preparing an installed battery case with an electrode assembly;
injecting the polymer electrolyte precursor composition of claim 3 into the battery case, followed by sealing; and
polymerizing the polymer electrolyte precursor composition.

13. A polymer electrolyte precursor composition capable to form a polymer electrolyte, comprising, consisting essentially of, or consisting of:
A) a monomer material consisting of vinyl ethylene carbonate and trimethylolpropane ethoxylate triacrylate;
B) a free radical initiator;
C) a lithium salt, such as lithium bis (fluorosulfonyl) imide; and
D) a organic solvent, preferably a carbonate solvent such as ethylene carbonate/dimethyl carbonate;
wherein the mass ratio of vinyl ethylene carbonate and trimethylolpropane ethoxylate triacrylate is 9.5:0.5-5:5, preferably 9.5:0.5-8:2, more preferably 9:1-8:2;
wherein the weight ratio of monomer material and the organic solvent is from 1:0 to 1:0.5, preferably 1:0.1-1:0.3, more preferably 1:0.2-1:0.3; and
wherein the amount of the monomer material is 50-95 wt. %, preferably 75-80 wt. % based on the total weight of the polymer electrolyte precursor composition.

14. Use of the monomer material of claim 1, or the polymer electrolyte precursor raw material composition of claim 2, or the polymer electrolyte precursor composition of claim 3, in preparation of an in-situ polymerized polymer electrolyte or an electrochemical device.
